(19) United States
(12) Patent Application Publication
(10) Pub. No.: US 2026/0323839 A1
(43) Pub. Date: Oct. 15, 2026

(54) DETERMINING THREE-DIMENSIONAL ELECTROMAGNETIC COUPLING OF HIGH VOLTAGE SWITCHING CIRCUITS AND SYSTEMS

(71) Applicant: Raytheon Company, Arlington, VA (US)

(72) Inventors: Thanh Thien Tran, Houston, TX (US); Dale E. Brech, Tucson, AZ (US); Debbie A. Walker, Tucson, AZ (US); Douglas P. Gugler, Sahuarita, AZ (US)

(21) Appl. No.: 19/179,516

(22) Filed: Apr. 15, 2025

(51) Int. Cl. H05K 3/00; G06F 30/3308; H05K 1/02; H05K 3/46

(52) U.S. Cl. CPC H05K 3/0005; G06F 30/3308; H05K 1/0256; H05K 3/4688

(57) ABSTRACT

A computer system performs a computer-implemented method of fabricating a multi-layer PCB. The computer system includes an electronic computer processor configured to execute program instructions to control the computer system to perform operations including generating a PCB stackup of a PCB to be fabricated, and identifying at least one target area included in the PCB stack. The at least one target area includes a first layer overlapping a second layer. The method further includes generating a 3D electromagnetic model of the at least one target area, generating an equivalent S-parameter circuit of the 3D electromagnetic model, determining a coupling voltage caused by at least one interference present in the at least one target area based on the S-parameter circuit, and modifying the S-parameter circuit to reduce the coupling voltage to meet a target coupling voltage. Accordingly, the PCB is fabricated having operating characteristics that meet the target voltage.

### BACKGROUND

The present disclosure generally relates to printed circuit board (PCB) fabrication, and more specifically, to determining three-dimensional electromagnetic coupling of high voltage switching circuits and systems.

High voltage switching circuits and systems are fundamental to power electronics, enabling efficient energy conversion in applications such as motor drives, power supplies, and grid-connected inverters. These high-voltage switching circuits are often times implemented on multi-layer printed circuit boards (PCBs), which provide electrical connectivity and thermal management while supporting high-speed switching components like metal-oxide-semiconductor field-effect transistors (MOSFETs), insulated-gate bipolar transistors (IGBTs), and silicon carbide (SiC) devices. The design of these high-voltage switching circuits involves careful consideration of insulation, grounding, and signal integrity to ensure performance and reliability. Advances in semiconductor technology and PCB manufacturing have led to more compact, high-efficiency designs that are widely used in industrial, automotive, and renewable energy applications.

### SUMMARY

According to a non-limiting embodiment, a method of fabricating a multi-layer printed circuit board (PCB) is provided. The method comprises generating a PCB stackup of a PCB to be fabricated, and identifying at least one target area included in the PCB stack, the at least one target area including a first layer overlapping a second layer. The method further comprises generating a three-dimensional (3D) electromagnetic model of the at least one target area, generating an equivalent S-parameter circuit of the 3D electromagnetic model, and determining a coupling voltage caused by at least one interference present in the at least one target area based on the S-parameter circuit. The method further comprises modifying the S-parameter circuit to reduce the coupling voltage to meet a target coupling voltage, and fabricating the PCB having operating characteristics that meet the target voltage.

In addition to one or more of the features described above, or as an alternative to any of the foregoing embodiments, the first layer is configured to receive a first voltage and the second layer is configured to receive a second voltage that is lower than the first voltage.

In addition to one or more of the features described above, or as an alternative to any of the foregoing embodiments, the first voltage ranges from about 100 volts (V) to about 150 V, and the second voltage ranges from about 1V to about 10 V.

In addition to one or more of the features described above, or as an alternative to any of the foregoing embodiments, the 3D electromagnetic model is generated in response to performing a full-wave analysis on the at least one at least one target area.

In addition to one or more of the features described above, or as an alternative to any of the foregoing embodiments, the equivalent S-parameter circuit comprises: a first input port defined at a first end of the first layer and a first output port defined at an opposing second end of the first layer; and a second output port defined at an end of the second layer.

In addition to one or more of the features described above, or as an alternative to any of the foregoing embodiments, the least one interference includes at least one of a capacitive coupling established by at least one capacitance pathway between the first and second layers, and an inductive coupling established by at least one inductance pathway between the first and second layer.

In addition to one or more of the features described above, or as an alternative to any of the foregoing embodiments, modifying the S-parameter circuit includes modifying one or both of the at least one capacitance pathway and the inductance pathway.

According to another non-limiting embodiment, a method of fabricating a multi-layer printed circuit board (PCB) is provided. The method comprises generating a PCB stackup of a PCB to be fabricated, the PCB stackup including an alternating stack of voltage planes and dielectric planes, identifying a first overlapping region defined by a first voltage plane among the voltage planes that overlaps a second voltage plane among the voltage planes, and identifying a second overlapping region defined by a third voltage plane among the voltage planes that overlaps a fourth voltage plane among the voltage planes. The method further comprise generating a three-dimensional (3D) electromagnetic model that includes the first overlapping region and the second overlapping region, generating an equivalent S-parameter circuit of the 3D electromagnetic model, and determining based on the S-parameter circuit a first coupling voltage caused by at least one interference present in the first overlapping region and at least one interference present in the second overlapping region. The method further comprises modifying the S-parameter circuit to reduce at least one of the first coupling voltage and the second coupling volage, and fabricating the PCB having operating characteristics t based on the modified S-parameter circuit.

In addition to one or more of the features described above, or as an alternative to any of the foregoing embodiments, the first voltage plane is configured to receive a first voltage, the second layer is configured to receive a second voltage, the third voltage plane is configured to receive a third voltage, and the fourth voltage plane is configured to receive a fourth voltage.

In addition to one or more of the features described above, or as an alternative to any of the foregoing embodiments, the 3D electromagnetic model is generated in response to performing a full-wave analysis on the first overlapping region and the second overlapping region.

In addition to one or more of the features described above, or as an alternative to any of the foregoing embodiments, the equivalent S-parameter circuit comprises: a first input port defined at a first end of the first voltage plane and a first output port defined at an opposing second end of the first voltage plane; a second output port defined at an end of the second voltage plane; a second input port defined at a first end of the third voltage plane, and a third output port defined at an end of the third voltage plane; and a fourth output port defined at an end of the fourth voltage plane.

The method of claim 11, In addition to one or more of the features described above, or as an alternative to any of the foregoing embodiments, the at least one interference present in the first overlapping region includes at least one of a capacitive coupling established by at least one capacitance pathway between the first and second voltage planes, and an inductive coupling established by at least one inductance pathway between the first and second voltage planes; and the at least one interference present in the second overlapping region includes at least one of a capacitive coupling established by at least one capacitance pathway between the third and fourth voltage planes, and an inductive coupling established by at least one inductance pathway between the third and fourth voltage planes.

In addition to one or more of the features described above, or as an alternative to any of the foregoing embodiments, modifying the S-parameter circuit includes modifying one or both of the at least one capacitance pathway and the inductance pathway of one or both of the at least one interference present in the first overlapping region and the at least one interference present in the second overlapping region.

According to yet another non-limiting embodiment, a computer system performs a computer-implemented method of fabricating a multi-layer PCB. The computer system includes an electronic computer processor configured to execute program instructions to control the computer system to perform operations including generating a PCB stackup of a PCB to be fabricated, and identifying at least one target area included in the PCB stack. The at least one target area includes a first layer overlapping a second layer. The method further includes generating a 3D electromagnetic model of the at least one target area, generating an equivalent S-parameter circuit of the 3D electromagnetic model, determining a coupling voltage caused by at least one interference present in the at least one target area based on the S-parameter circuit, and modifying the S-parameter circuit to reduce the coupling voltage to meet a target coupling voltage. Accordingly, the PCB is fabricated having operating characteristics that meet the target voltage.

Other embodiments of the present disclosure implement features of the above-described method in computer systems and computer program products.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the disclosure are apparent from the following detailed description taken in conjunction with the accompanying drawings in which:

FIG. 1 depicts a PCB stackup of a multi-layer PCB;

FIG. 2 depicts an example of a region of overlapping PCB layers included in a multi-layer PCB;

FIG. 3 depicts another example of a region of overlapping PCB layers included in a multi-layer PCB;

FIGS. 4A and 4B are graphs depicting the voltage waveforms associated with capacitive coupling and inductive coupling;

FIG. 5 depicts an example of an S-parameter model of a 4-port RF network;

FIG. 6 depicts a block diagram of an example system capable of determining three-dimensional electromagnetic coupling of high voltage switching circuits systems for designing and fabricating a PCB according to a non-limiting embodiment of the present disclosure;

FIG. 7 depicts a block diagram of an example computer system for use in conjunction with one or more non-limiting embodiments of the present disclosure;

FIG. 8 is a block diagram of a system employing a simulator that utilizes a simulation model that accurately determines three-dimensional electromagnetic coupling of high voltage switching circuits and systems according to a non-limiting embodiment of the present disclosure; and

FIG. 9 is a flow diagram illustrating a method of fabricating a PCB based on an analysis of 3D electromagnetic coupling of high voltage switching circuits included in the design of the PCB is illustrated according to a non-limiting embodiment of the present; disclosure;

FIG. 10 depicts a multi-layer PCB including a plurality of stacked layers according to a non-limiting embodiment of the present disclosure;

FIG. 11 depicts a 3D electromagnetic model of a multi-layer PCB including an overlapping region defined by an upper layer and lower layer according to a non-limiting embodiment of the present disclosure;

FIG. 12 depicts an equivalent S-parameter circuit of a 3D electromagnetic model (S-parameter model) according to a non-limiting embodiment of the present disclosure;

FIG. 13 depicts an 8-port 3D electromagnetic model (S-parameter model) of a multi-layer PCB according to a non-limiting embodiment of the present disclosure; and

FIG. 14 is a flow diagram illustrating a method of determining 3D electromagnetic coupling of a high voltage switching circuit according to a non-limiting embodiment of the present disclosure.

### DETAILED DESCRIPTION

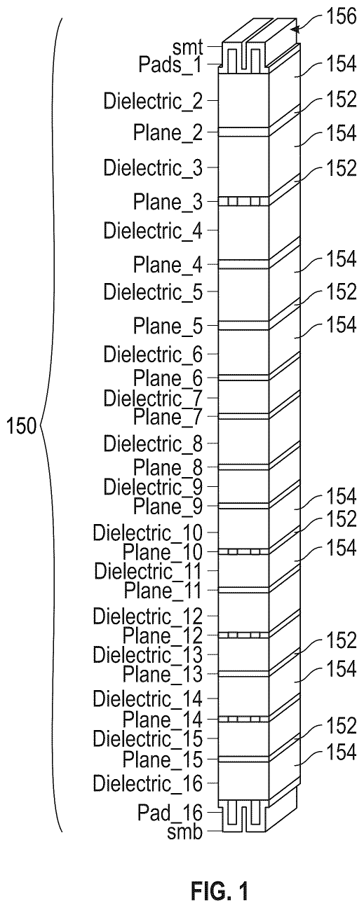

Designing high voltage switching circuits for motor controllers and power supplies presents significant challenges related to electromagnetic interference (EMI), signal integrity, and system reliability, particularly in multi-layer PCB layouts. FIG. 1, for example, depicts an example of a PCB stackup 150 including an arrangement of conductive layers 152 and insulating layers 154 of a multi-layer PCB 156.

In high-speed AC switching systems, however, the AC switching transitions generate rapid voltage and current changes, leading to unintended capacitive, inductive, and radiative coupling between circuit elements. A critical issue arises when high-voltage (e.g., 135V) and low-voltage (e.g., 5V) planes overlap on a multi-layer PCB, creating coupling paths that introduces noise into sensitive control signals. Two coupling mechanisms exist in the presence of overlapping adjacent layers: (1) Capacitive coupling; and (2) Inductive coupling. The magnitude of the coupling voltage depends on parasitics (i.e., the capacitance parasitics and/or inductance parasitics) of the two layers.

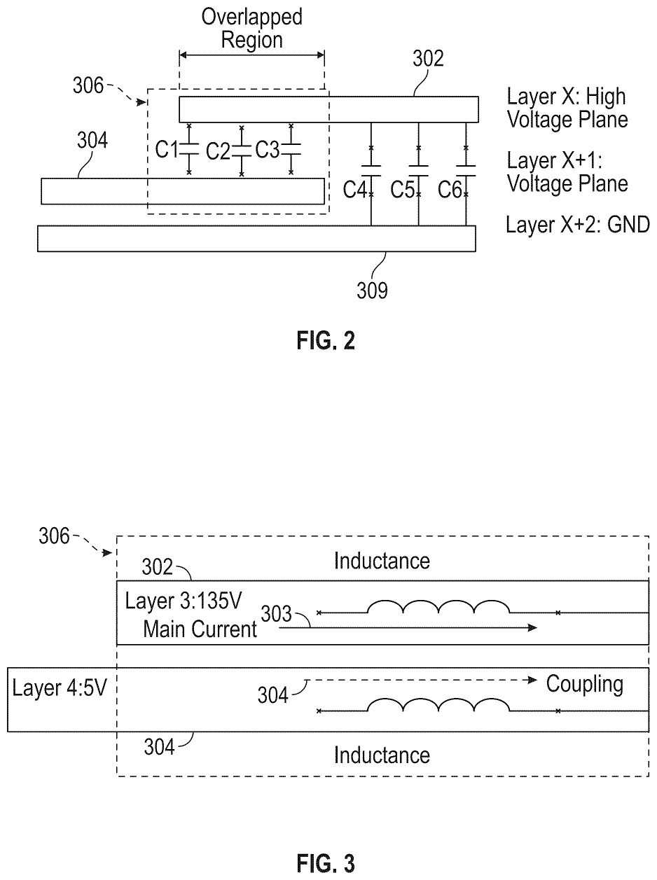

FIG. 2, for example, depicts an overlapping region 306 included in a multi-layer PCB. The overlapping region 306 includes an upper layer 302 and a lower layer 304. The distance between the upper layer 302 and the lower layer 304 defines capacitances (C1, C2, C3), while the distance between the upper layer 302 and a ground plane 309 defines capacitances (C4, C5, C6). Therefore, the total plane capacitance (C) of the overlap region (i.e., between the upper layer 302 and the lower layer 304) is defined as: C=C1+C2+C3.

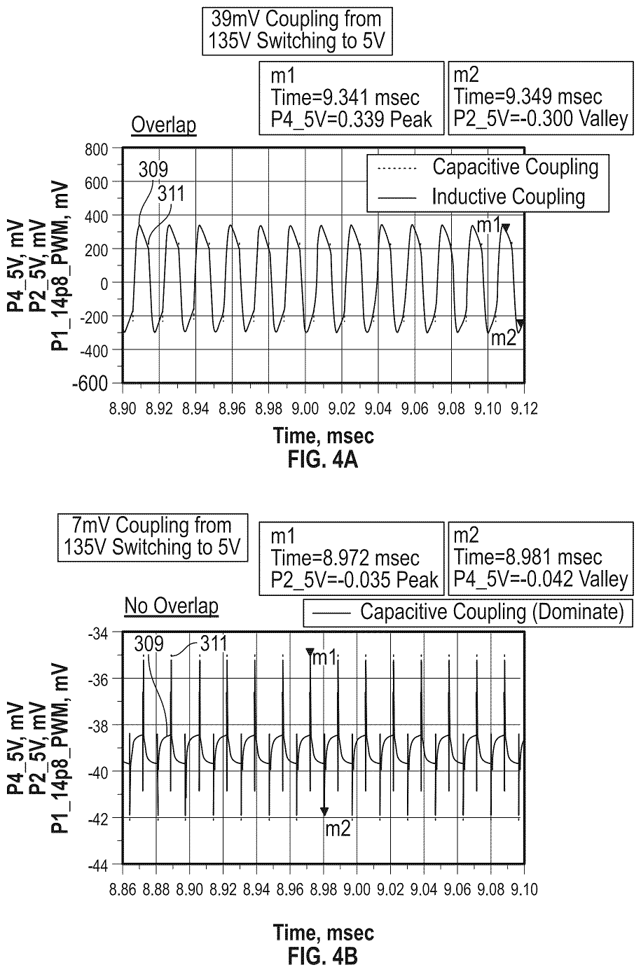

FIG. 3 is another example of an overlapping region 306 defined by an upper layer 302 spaced apart from and a lower layer 304. High-speed main alternating current (AC) 303 flowing through the upper layer 302 induces an electromagnetic (EM) flux that interacts with the lower layer 304 to produce an inductive coupling effect. The EM flux can energize the lower layer 304, and induce an undesired coupling current 305, which flows through the lower layer 304. As a result, the voltage (V_{layer4}) realized by the lower layer 304 can be defined as V_{layer4}=a*V_{layer3}, where “a” is the coupling coefficient, depending on parasitic inductance between the upper layer 302 (layer 3) and the lower layer 304 (layer 4).
FIGS. 4A and 4B are graphs depicting the voltage waveforms associated with capacitive coupling and inductive coupling. When two layers overlap one another, the voltage waveform produced from inductive coupling (309) has the same waveform as the switching waveform, while the voltage waveform produced from capacitive coupling (311) is a differentiated version of the waveform, i.e., spikes at the rising and falling edge of waveform 311, as shown FIG. 4A. Removing the overlap reduces the coupling noise from 639 mV to 7 mV (about 91-times reduction), as shown in FIG. 4B.

In radio frequency (RF) and microwave systems, scattering parameters (S-parameters) are used to model a channel of multi-port RF network. For example, S-parameters can be used to identify, quantify, and analyze the effects of parasitic capacitance and inductance interferences. The analysis allows for designing matching networks, layout adjustments, and/or the implementation of interference compensating components to minimize the parasitic interference in the final design of the RF circuit network.

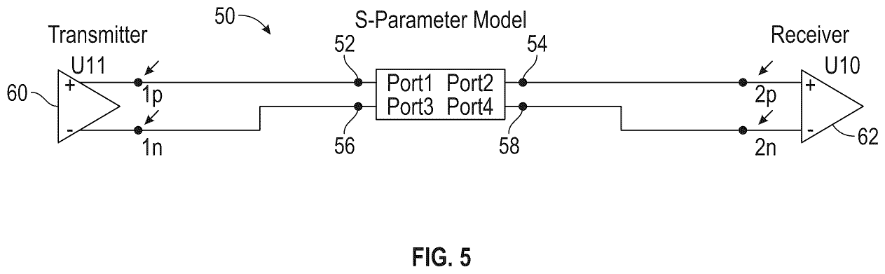

FIG. 5, for example, depicts an example of an S-parameter model of a 4-port RF network 50. The 4-port RF network 50 includes a first port 52, a second port 54, a third port 56, and a fourth port 58. The first and second ports 52 and 54 are designated as positive input and output ports, respectively. Likewise, the third and fourth ports 56 and 58 are designated as negative input and output ports, respectively. These two transmission paths in one differential pair are known as Differential Insertion Loss (DIL). The signal coupling paths among the first port 42 and the third/fourth 56/58, and the third port 56 and the first/second ports 52/54 are known as Differential Return Loss (DRL). Both DIL and DRL define the “channel” of the RF network 50.

In the example shown in FIG. 5, the RF network 50 transmits a differential signal from the transmitter 60 through the S-parameter channel and to the receiver 62. The differential signal includes an positive in-phase signal (Vp) and a negative out-of-phase signal (Vn). Transmitting the signal differentially with common mode noise and coupling (Vnoise) equal to Vp and Vn allows the receiver 62 to cancel the common mode noise as defined by the equation:

$$V receiver = Gain ( ( V p + V noise ) - ( V n + V noise ) ) = 2 V p for Gain = 1$$

In high-voltage switching systems, the parasitic capacitance and/or inductance interferences described above can result in unpredictable behavior, data corruption, or even system failures. Developing an accurate 3D simulation model to predict these coupling mechanisms is complex due to the interplay of parasitic capacitance, inductive crosstalk, and transient voltage fluctuations, making PCB design strategies such as plane separation, optimized grounding, and controlled impedance routing essential for system stability.

One or more embodiments of the present disclosure provide a system and method capable of determining three-dimensional electromagnetic coupling of high voltage switching circuits and systems for designing and fabricating a PCB. According to a non-limiting embodiment, the system and method involves identifying one or more target areas that experience high voltage switching and generating a 3D electromagnetic model of the target areas. In one or more embodiments, generating the 3D electromagnetic model utilizes radio frequency (RF) and microwave modeling techniques such as a scattering matrix that utilizes scattering parameters or S-parameters to generate a model (e.g., a “S-parameter model”) indicative of the radiation pattern that occurs in the target areas. Once the S-parameter model is generated, the system and method generates an equivalent S-parameter circuit of the multi-layer PCB to determine the interferences of the high voltage switching regions in one or more of the overlapping high-power switching regions. Once the interferences of the high voltage switching regions are identified, the equivalent S-parameter circuit is modified to reduce the coupling voltage and achieve a target coupling voltage. Based on the modified equivalent S-parameter circuit, a physical PCB can be designed and fabricated with characteristics that meet the target coupling voltage.

The system and method described according to various non-limiting embodiments of the present disclosure addresses the challenges of determining 3D electromagnetic coupling of high voltage switching circuits and systems by systematically identify and model high-voltage switching regions on a multi-layer PCB, allowing for precise detection of interference mechanisms using 3D electromagnetic analysis and S-parameters. In a non-limiting embodiment, an input port and an output port are assigned to opposing ends of an upper layer, and an input port and an output port are assigned to opposing ends of a lower layer. Accordingly, the overlapping upper and lower layers can be modeled as overlapping differential RF or microwave signals. A 3D S-parameter extraction of the overlap is then performed and the results used to generate an equivalent S-parameter circuit. By generating an equivalent S-parameter circuit, the method enables engineers to analyze, predict, and modify coupling pathways (e.g., the capacitance pathways and/or the inductance pathways) before physical prototyping, thereby reducing unwanted voltage interference between high-voltage (e.g., 135V) and low-voltage (e.g., 5V) planes. This approach optimizes PCB design and layout, ensuring reliable system performance by achieving a target coupling voltage that mitigates EMI-induced failures.

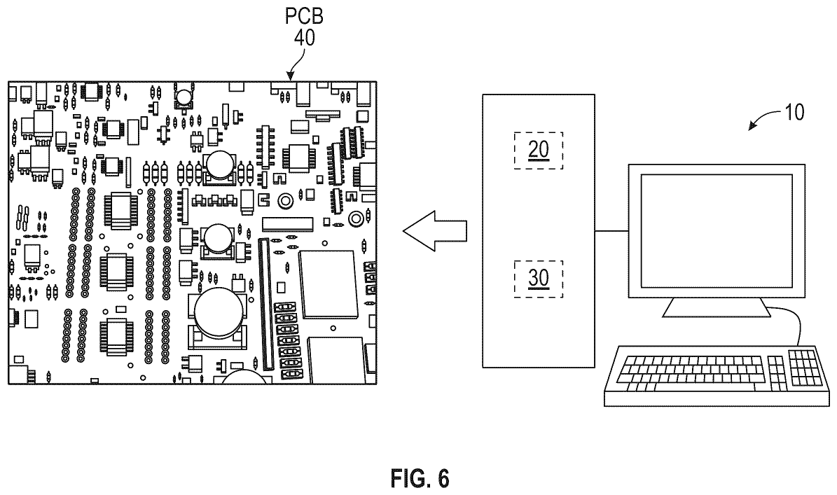

With reference now to FIG. 6, a block diagram of a system 10 capable of determining three-dimensional (3D) electromagnetic coupling of high voltage switching circuits and systems is illustrated according to one or more embodiments of the disclosure. The system 10 includes processing circuitry 20 and memory 30 storing one or more software programs and code (collectively referred to as software). The software can include, but is not limited to, computer readable program instructions for carrying out operations of the present disclosure, assembler instructions, instruction-set-architecture (ISA) instructions, simulator programs, workload traces, cache layout information, instruction and data addresses, machine instructions, machine dependent instructions, microcode, firmware instructions, state-setting data, configuration data for integrated circuitry, or either source code or object code written in any combination of one or more programming languages, including an object oriented programming language such as Smalltalk, C++, Spice, VHDL, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server.

The processing circuitry 20 and software (e.g., a Fullwave 3D Electromagnetic Solver) stored in the memory 30 can be used to simulate and measure the performance (e.g., a system-level performance) of a circuit or PCB design including overlapping layers of a multi-PCB design. For example, the processing circuitry 20 and software can operate together to execute a simulator that simulates electromagnetic field (EMF) interactions associated with a 3D modeled PCB. The software can include a plurality of stored 3D models of a PCB including metal traces, planes vias, dielectric materials, PCB components, excitation ports. Based on the 3D model, the simulator can analyze S-parameters which can indicate radiation parameters used to develop an equivalent S-parameter circuit. The equivalent S-parameter circuit can then be used to determine the capacitance coupling interference and/or inductance coupling interference of high voltage switching regions in the PCB design.

The equivalent S-parameter circuit can then be modified to reduce the coupling voltage caused by previously identified capacitance coupling interference and/or inductance coupling interference to meet a targeted coupling voltage. Once the modified PCB design meets targeted coupling voltage, the design can be ultimately fabricated into a physical PCB 40. The steps involved in the fabrication of the PCB 40 are well-known and only briefly described herein. The physical layout is then finalized and is provided to a “PCB fabrication house”, which uses a combination of automated processes including, but not limited to, photolithography, etching, drilling, and plating, to create the physical circuit patterns, layers, and planes on the board based on the modified PCB design generated by the 3D electromagnetic coupling analysis system 10.

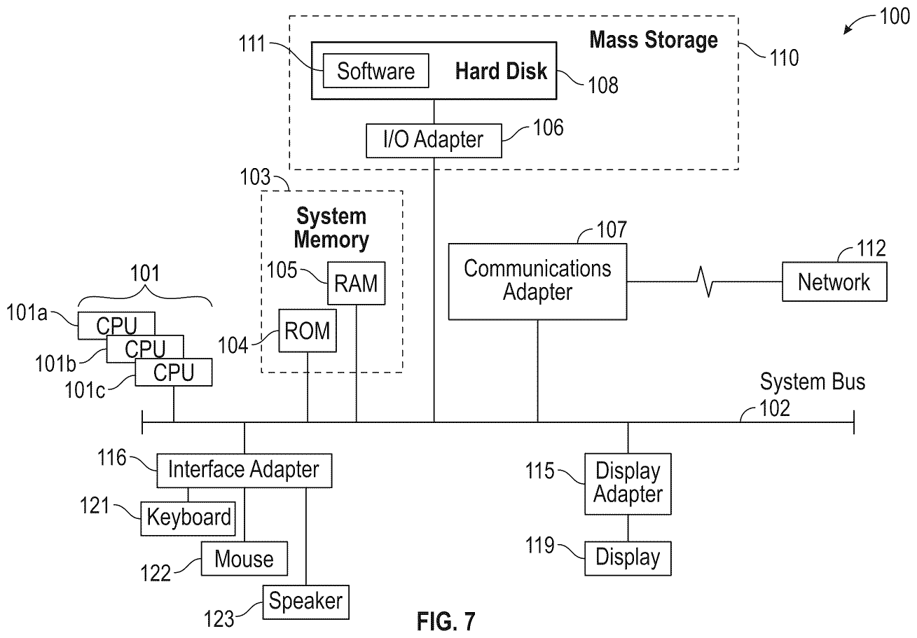

Turning now to FIG. 7, a computer system 100 is generally shown in accordance with one or more embodiments of the disclosure. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 7.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 7, the computer system 100 includes processing capability in the form of the processors 101, and storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 7 is not intended to indicate that the computer system 100 is to include all of the components shown in FIG. 7. Rather, the computer system 100 can include any appropriate fewer or additional components not illustrated in FIG. 7 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

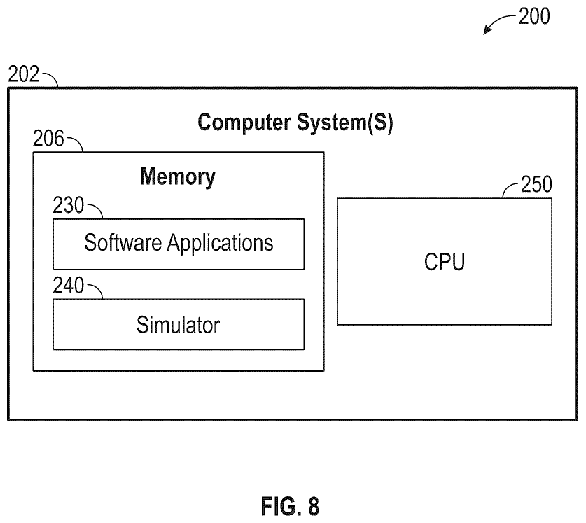

Referring to FIG. 8, a block diagram of a system 200 employing a simulator that determines 3D electromagnetic coupling of high voltage switching circuits for implementation in a PCB according to a non-limiting embodiment. The system 200 includes one or more computer systems 202. One or more elements of the system 100 illustrated in FIG. 8 may be used in and/or integrated into computer system 202. One or more software applications and/or models 230 can be utilized by the simulator 240 and executed by a CPU 250 to generate a 3D model of a designed PCB, generate 3D electromagnetic models of high voltage switching areas included in the designed PCB, and develop an equivalent S-parameter circuit that can be simulated and analyzed to determine the capacitance and/or inductive coupling interferences of the high voltage switching regions. The software applications 230 can include, be integrated with, and/or employ various types of software including but not limited to hardware description languages (HDLs) including, but not limited to, Simulation Program with Integrated Circuit Emphasis (SPICE), Hierarchical SPICE (HSPICE), a Fullwave 3D Electromagnetic Solver, and Printed Circuit Board Hardware Description Language (PHDL), to create 3D representations of a PCB and/or multi-level PCB.

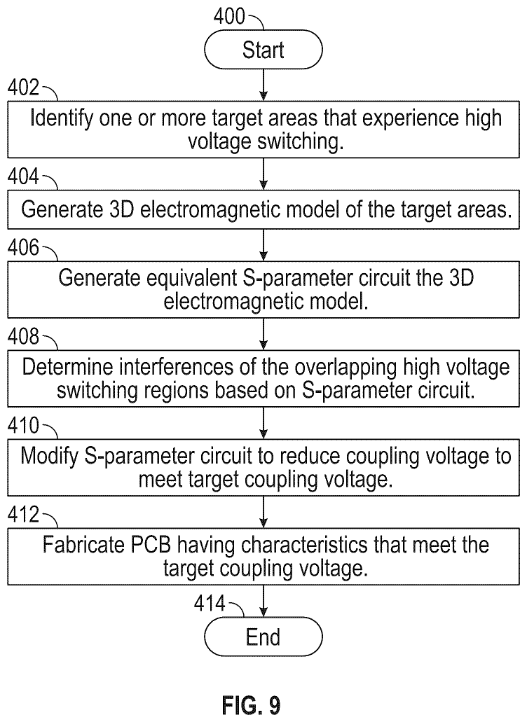

Turning now to FIG. 9, a method of providing a PCB based on an analysis of 3D electromagnetic coupling of high voltage switching circuits included in the design of the PCB is illustrated according to a non-limiting embodiment of the present disclosure. The method begins at operation 400 and proceeds to operation 402 to identify one or more target areas that experience high voltage switching. In a non-limiting embodiment, a target area includes an area of the PCB that includes overlapping regions of stacked adjacent layers of the PCB.

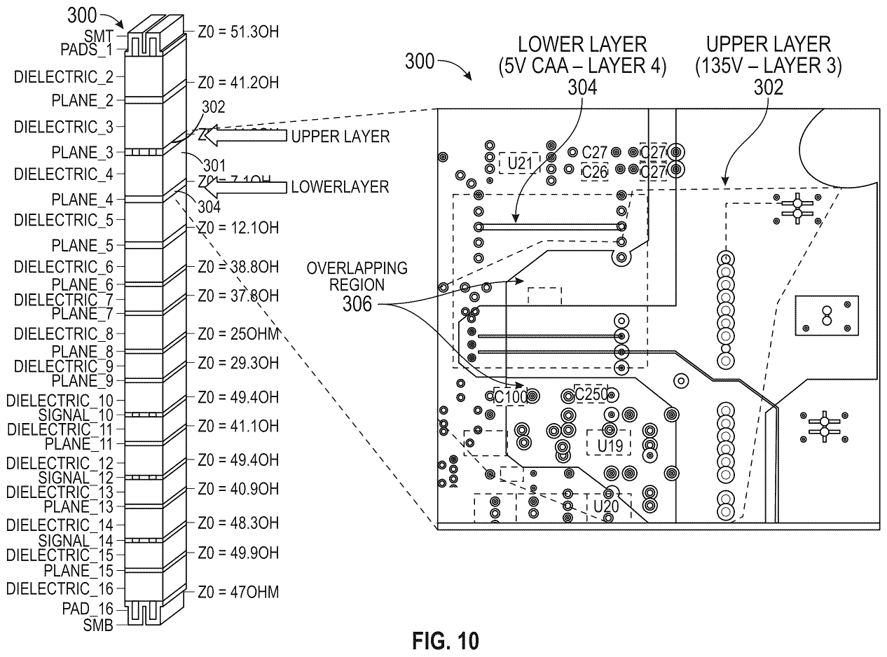

FIG. 10, for example, depicts a multi-layer PCB 300 including a plurality alternating stack of voltage layers and dielectric layers. In a non-limiting embodiment, the PCB 300 includes a first layer 302 referred to herein as an upper layer 302 and a second layer 304 referred to herein as a lower layer 304. The first layer 32 and the second layer 304 are separated from one another by a dielectric layer 301 or dielectric plane interposed therebetween. In a non-limiting embodiment, the upper layer 302 is considered a high-voltage layer configured to receive a first voltage while the lower layer 304 is considered a low-voltage layer configured to receive a second voltage that is lower than the first voltage. For example, the upper layer 302 may support high-speed switching components and may receive a high voltage (to drive the high-speed switching components) ranging from about 100V to about 150V, and preferably at about 135V, while the lower layer 304 may support low voltage components and may receive a low voltage (to drive the low voltage components) ranging from about 1V to about 10V, and preferably at about 5V. It should be appreciated that the voltage ranges associated the upper layer 302 and lower layer 304 may vary without changing the scope of the present disclosure.

The upper layer 302 and the lower layer 304 overlap and are separated by one another to define an overlap region 306. The overlap region 306 can be identified, for example, by manual inspection or predetermined design of the multi-layer PCB 300. In a non-limiting embodiment, the separation between the upper layer 302 and the lower layer 304 is about 5 mils ( 5/1000 of an inch). It should be appreciated, however, that the separation distance between adjacent upper and lower layers can vary based on the design of the multi-layer PCB 300.

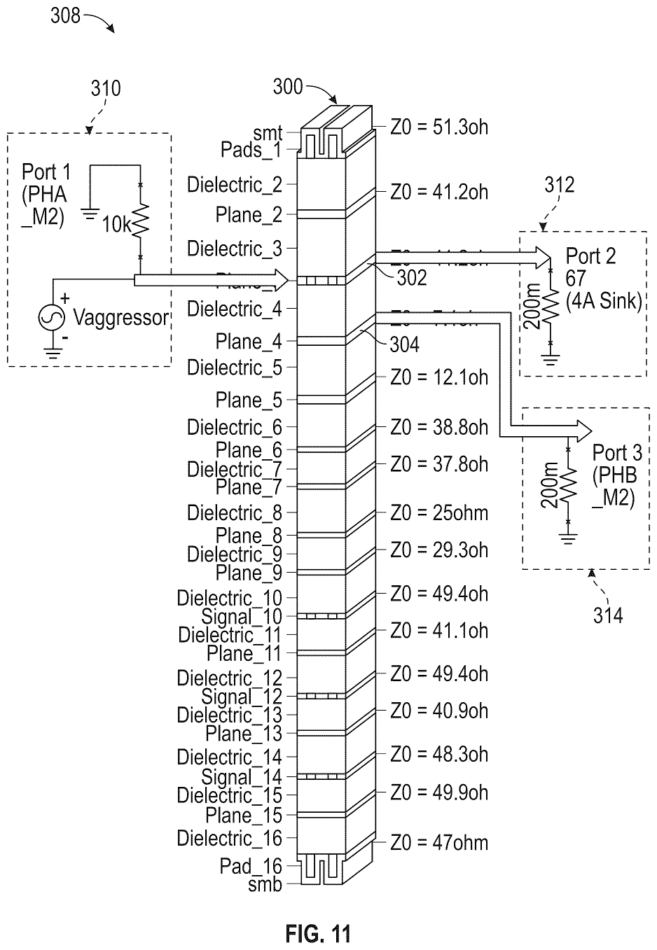

With reference again to FIG. 9 along with FIG. 11, a 3D electromagnetic model of the target area(s) is generated at operation 404. FIG. 11, for example, depicts a 3D electromagnetic model 308 of the overlapping region 306 defined by the upper layer 302 and the lower layer 304 shown in FIG. 10. In a non-limiting embodiment, the 3D electromagnetic model 308 can be expressed as a “S-parameter model”, which is generated using Scattering Parameters (referred to as “S-parameters”) that are determined based on the arrangements of the upper layer 302 and the lower layer 304.

In at least one non-limiting embodiment, the S-parameter model 308 includes the overlapping region 306 (see FIG. 10) defined by the upper layer 302, lower layer 304, and equivalent circuits of an input port 310, a first output port 312, and a second output port 314. The input port circuit 310 is defined at (e.g., connected to) one end of upper layer 302, while the first output port circuit 312 is defined at (e.g., connected to) an opposing end of the upper layer 302 The second output port circuit 314 is defined at (e.g., connected to) an end of lower layer 304. The input port circuit 310 may be referred to as an “aggressor switching source,” which can cause cross-talk interference between the first output port circuit 312 and the second output port circuit 314. Accordingly, the first and second output port circuits 312 and 314 may be referred to as “victim cross-talk circuits”. This cross-talk interference can include capacitance coupling interference and/or inductive coupling interference, each which can analyzed using an equivalent S-parameter circuit as discussed in greater detail below.

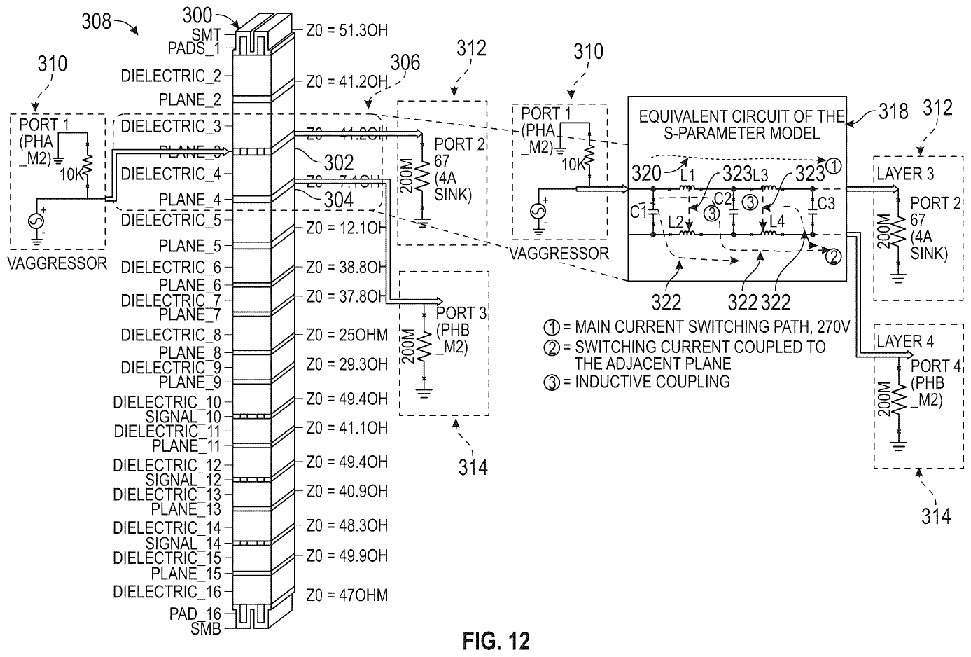

Referring again to FIG. 4, along with FIG. 12, an equivalent S-parameter circuit 318 of the 3D electromagnetic model 308 (i.e., the S-parameter model) is generated at operation 406. In a non-limiting embodiment, the equivalent S-parameter circuit 318 can be generated using SPICE or HSPICE, for example. To demonstrate the coupling mechanism, the equivalent S-parameter circuit 318 shown in FIG. 12 can define a main circuit path 320 and one or more capacitance leakage switching current paths 322 (e.g., capacitance pathways), and one or more inductance leakage switching current paths 323 (e.g., inductance pathways). The main circuit path 320 extends from the input port 310, through the upper layer 302, and to the first output port 312. The capacitance leakage switching current path(s) 322 extend from the first port 310, through the lower layer 304 via one or more of the capacitances (C1, C2, C3, etc.) coupling together the upper and lower layers 302 and 304, before flowing into the second output port 314. The inductance leakage paths 323 are induced in response to the magnetic inductive coupling effect that occurs between the inductances L1 and L3 of the upper layer 302 and the inductances L2 and L4 of the lower layer 304. Accordingly, the magnitude of the total coupling voltage that exists in the equivalent S-parameter circuit 318 depends on the parasitics (capacitance and inductance) between the upper layer 302 and the lower layer 304. In the example shown in FIG. 12, the switching current (I) coupled to the second output port 314 can be estimated as I=C(dv/dt), where “C” is the total plane capacitance (C=C1+C2+C3).

With reference again to FIG. 4, capacitance and inductive coupling interferences of the target regions (e.g., the overlap region 306) are determined and analyzed based on the S-parameter circuit 318 at operation 408. The analysis can include, for example, determining the amount of cross-talk interference (both capacitance and inductance) between the first output port 312 and the second output port 314 (see FIG. 12).

At operation 410, the S-parameter circuit 318 is modified to reduce the coupling voltage between the upper and lower layers 302 and 304 to meet a target coupling voltage. The target coupling voltage can be defined, for example, as a coupling voltage that satisfies a coupling voltage threshold or is below coupling voltage threshold. In a non-limiting embodiment, the S-parameter circuit 318 can be modified by modifying the coupling pathways (e.g., the capacitance pathways and/or the inductance pathways) existing between the upper and lower layers 302 and 304 before physical prototyping. Once the target coupling voltage is verified according to the simulation of the S-parameter circuit 318, a physical PCB having operating characteristics that meet the target coupling voltage is then fabricated at operation 412, and the method ends at operation 414.

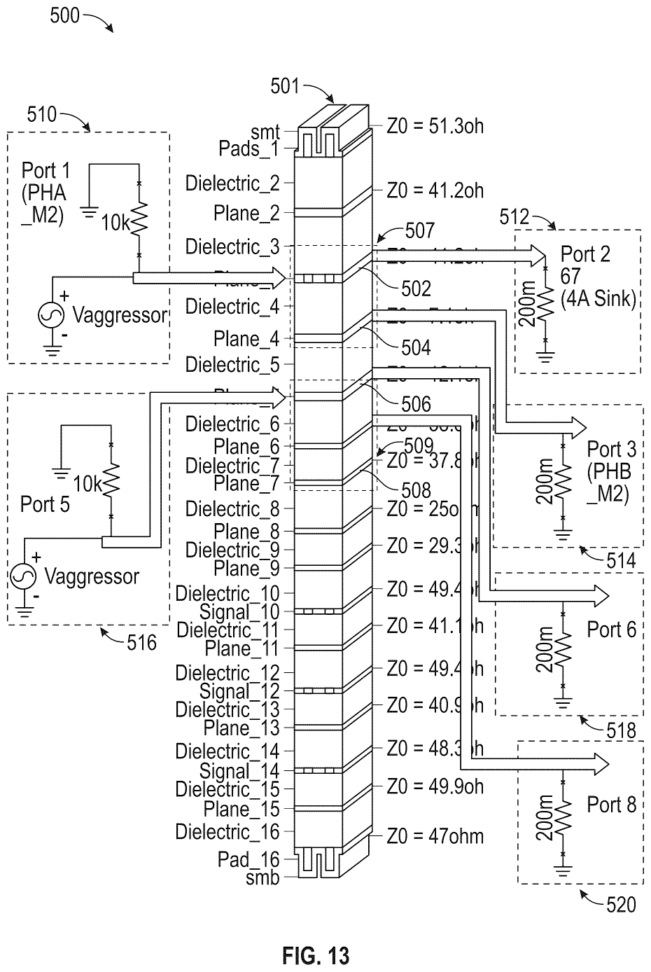

The non-limiting embodiment of the method described above is applied to a 4-port RF network including two voltage planes or two voltage layers. It should be appreciated, however, that the method can apply to an RF network including additional ports and additional voltage planes. FIG. 13, for example, depicts an 8-port S-parameter model 500 for analyzing four voltage layers of a multi-layer PCB 501 according to a non-limiting embodiment of the present disclosure. The multi-layer PCB 501 includes a first voltage layer 502 (e.g., 135V layer), a second voltage layer 504 (e.g., 5V layer), a third voltage layer 506 (12V layer), and a fourth voltage layer 508 (3.3V layer). In a non-limiting embodiment, the first voltage layer 502 and the second voltage layer 504 define a first overlapping region 507 between one another, while the third voltage layer 506 and the fourth voltage layer 508 define a second overlapping region 509 between one another.

The multi-layer PCB 501 can be modeled according to the S-parameter model 500, which includes a first port 510, a second port 512, a third port 514, a fifth port 516, a sixth port 518, and an eighth port 520. In this example, an 8-port S-parameter model 500 can be utilized, with the fourth and seventh ports unused. The first port 510 and the second port 512 can serve as a 135V input and 135V load, respectively, of the first voltage layer 502. The third port 514 can serve to establish the second voltage layer 504 as a 5V victim plane. The fifth port 516 and the sixth port 518 can serve as a 12V input and 12v load, respectively, of the third voltage layer 506. The eighth port 520 can serve to establish the fourth voltage layer 508 as a 3.3V victim plane. For the victim planes (e.g., voltage layers 504 and 508), it should be appreciated that unused ports 4 and 7 can be used instead of the third port 514 and the eighth port 520 without departing from the scope of the present disclosure. Accordingly, the S-parameter model 500 can be utilized to determine the capacitance and inductance coupling interference from one voltage layer 502-508 to any of the other three voltage layers 502-508.

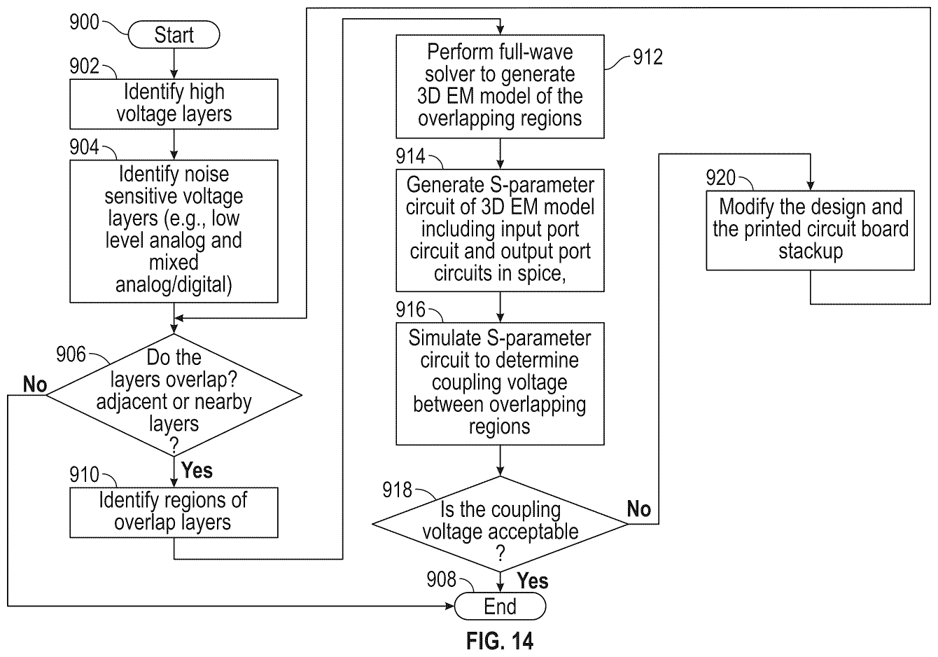

FIG. 14 is a flow diagram illustrating a method of determining 3D electromagnetic coupling of a high voltage switching circuit is illustrated according to a non-limiting embodiment of the present disclosure. The method begins at operation 900, and at operation 902 identifies one or more high voltage layers included in a multi-layer PCB. At operation 904, noise sensitive voltage layers such as low level analog voltage and/or mixed analog/digital voltage layers, for example, are identified. As described herein, the high voltage layers and/or noise sensitive voltage layers can be identified by manually inspecting the PCB and/or a PCB stackup design.

At operation 906, a determination is made as to whether the high voltage layers and noise sensitive voltage layers overlap one another (e.g., by manual identification). When the high voltage layers and noise sensitive voltage layers do not overlap one another, the method ends at operation 908. Otherwise, overlapping regions of the high voltage layers and noise sensitive voltage layers are identified at operation 910.

At operation 912, a 3D EM model (e.g., S-parameter model) of the overlapping regions is generated. In a non-limiting embodiment, a full-wave analysis (e.g., using a full-wave solver) is performed to generate the 3D model of the overlapping regions. In a non-limiting embodiment, the full-wave analysis involves performing a computational analysis to solve Maxwell's equations without simplification to accurately model wave propagation, reflections, scatterings, and/or other energy interactions using numerical methods such as finite element methodology (FEM), method of moments (MoM) and/or finite-difference time-domain (FDTD), all of which can be performed using various software simulation programs such as, for example, full-wave solver.

At operation 914, an S-parameter circuit including an input port switching circuit and output port circuits is generated based on the 3D EM model. In a non-limiting embodiment, the input port switching circuit and output port circuit(s) are generated using, for example, SPICE or HSPICE.

At operation 916, the S-parameter circuit is simulated to determine the coupling voltage (e.g., both capacitance coupling and inductive coupling voltages) between overlapping regions, and a determination as to whether the coupling voltage is acceptable (e.g., below a coupling voltage threshold) is performed at operation 918. When the coupling voltage is acceptable, the method ends at operation 908. Otherwise, the design of the PCB is modified at operation 920 (e.g., modifying the coupling pathways existing between the upper and lower overlapping layers) and the method returns to operation 906. The analysis can then be repeated until the coupling voltage is acceptable, and the method ends at operation 908.

### CONCLUSION

As described herein, one or more embodiments of the present disclosure provide a system and method capable of determining 3D electromagnetic coupling of high voltage switching circuits and systems for designing and fabricating a PCB. According to a non-limiting embodiment, the system and method involves identifying one or more target areas that experience high voltage switching and generating a 3D electromagnetic model of the target areas. In one or more embodiments, generating the 3D electromagnetic model utilizes RF and microwave modeling techniques such as a scattering matrix that utilizes scattering parameters or S-parameters to generate a model indicative of the radiation pattern that occurs in the target areas. A coupling circuit can then be generated, which enables analysis of coupling voltage and facilitates the modification (e.g., modification of coupling pathways before physical prototyping) to reduce the coupling voltage to meet target coupling voltage specifications, thereby reducing unwanted voltage interference between high-voltage (e.g., 135V) and low-voltage (e.g., 5V) planes. Accordingly, the system is capable of optimizing PCB design and layout, ensuring reliable system performance by achieving a target coupling voltage that mitigates EMI-induced failures.

Various embodiments of the present disclosure are described with reference to the related drawings. Alternative embodiments of the present disclosure can be devised without departing from the scope of this disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method of fabricating a multi-layer printed circuit board (PCB), the method comprising:
generating a PCB stackup of a PCB to be fabricated;
identifying at least one target area included in the PCB stack, the at least one target area including a first layer overlapping a second layer;
generating a three-dimensional (3D) electromagnetic model of the at least one target area;
generating an equivalent S-parameter circuit of the 3D electromagnetic model;
determining a coupling voltage caused by at least one interference that is present in the at least one target area based on the S-parameter circuit;
modifying the S-parameter circuit to reduce the coupling voltage to meet a target coupling voltage; and
fabricating the PCB having operating characteristics that meet the target voltage.

2. The method of claim 1, wherein the first layer is configured to receive a first voltage and the second layer is configured to receive a second voltage that is lower than the first voltage.

3. The method of claim 2, wherein the first voltage ranges from about 100 volts (V) to about 150 V, and the second voltage ranges from about 1V to about 10 V.

4. The method of claim 2, wherein the 3D electromagnetic model is generated in response to performing a full-wave analysis on the at least one target area.

5. The method of claim 3, wherein the equivalent S-parameter circuit comprises: a first input port defined at a first end of the first layer and a first output port defined at an opposing second end of the first layer; and
a second output port defined at an end of the second layer.

6. The method of claim 5, wherein the least one interference includes at least one of a capacitive coupling established by at least one capacitance pathway between the first and second layers, and an inductive coupling established by at least one inductance pathway between the first and second layer.

7. The method of claim 3, wherein modifying the S-parameter circuit includes modifying one or both of the at least one capacitance pathway and the at least one inductance pathway.

8. A method of fabricating a multi-layer printed circuit board (PCB), the method comprising:
generating a PCB stackup of a PCB to be fabricated, the PCB stackup including an alternating stack of voltage planes and dielectric planes;
identifying a first overlapping region defined by a first voltage plane among the voltage planes that overlaps a second voltage plane among the voltage planes;
identifying a second overlapping region defined by a third voltage plane among the voltage planes that overlaps a fourth voltage plane among the voltage planes;
generating a three-dimensional (3D) electromagnetic model that includes the first overlapping region and the second overlapping region;
generating an equivalent S-parameter circuit of the 3D electromagnetic model;
determining, based on the S-parameter circuit, a first coupling voltage caused by at least one interference that is present in the first overlapping region and at least one interference that is present in the second overlapping region;
modifying the S-parameter circuit to reduce at least one of the first coupling voltage and the second coupling volage; and
fabricating the PCB having operating characteristics t based on the modified S-parameter circuit.

9. The method of claim 8, wherein the first voltage plane is configured to receive a first voltage, the second layer is configured to receive a second voltage, the third voltage plane is configured to receive a third voltage, and the fourth voltage plane is configured to receive a fourth voltage.

10. The method of claim 9, wherein the 3D electromagnetic model is generated in response to performing a full-wave analysis on the first overlapping region and the second overlapping region.

11. The method of claim 8, wherein the equivalent S-parameter circuit comprises: a first input port defined at a first end of the first voltage plane and a first output port defined at an opposing second end of the first voltage plane;
a second output port defined at an end of the second voltage plane;
a second input port defined at a first end of the third voltage plane, and a third output port defined at an end of the third voltage plane; and
a fourth output port defined at an end of the fourth voltage plane.

12. The method of claim 11, wherein:
the at least one interference present in the first overlapping region includes at least one of a capacitive coupling established by at least one capacitance pathway between the first and second voltage planes, and an inductive coupling established by at least one inductance pathway between the first and second voltage planes; and
the at least one interference present in the second overlapping region includes at least one of a capacitive coupling established by at least one capacitance pathway between the third and fourth voltage planes, and an inductive coupling established by at least one inductance pathway between the third and fourth voltage planes.

13. The method of claim 9, wherein modifying the S-parameter circuit includes modifying one or both of the at least one capacitance pathway and the at least one inductance pathway of one or both of the at least one interference present in the first overlapping region and the at least one interference present in the second overlapping region.

14. A computer system configured to perform a computer-implemented method of fabricating a multi-layer printed circuit board (PCB), the computer system comprising:
a computer readable storage medium having program instructions embodied therewith; and
an electronic computer processor configured to execute the program instructions to control the computer system to perform the computer-implemented method including operations comprising:
generating a PCB stackup of a PCB to be fabricated;
identifying at least one target area included in the PCB stack, the at least one target area including a first layer overlapping a second layer;
generating a three-dimensional (3D) electromagnetic model of the at least one target area;
generating an equivalent S-parameter circuit of the 3D electromagnetic model;
determining a coupling voltage caused by at least one interference present in the at least one target area based on the S-parameter circuit; and
modifying the S-parameter circuit to reduce the coupling voltage to meet a target coupling voltage,
wherein the PCB is fabricated having operating characteristics that meet the target voltage.

15. The computer system of claim 14, wherein the first layer is configured to receive a first voltage and the second layer is configured to receive a second voltage that is lower than the first voltage.

16. The computer system of claim 15, wherein the first voltage ranges from about 100 volts (V) to about 150 V, and the second voltage ranges from about 1V to about 10 V.

17. The computer system of claim 15, wherein the 3D electromagnetic model is generated in response to performing a full-wave analysis on the at least one target area.

18. The computer system of claim 16, wherein the equivalent S-parameter circuit comprises:
a first input port defined at a first end of the first layer and a first output port defined at an opposing second end of the first layer; and
a second output port defined at an end of the second layer.

19. The computer system of claim 18, wherein the least one interference includes at least one of a capacitive coupling established by at least one capacitance pathway between the first and second layers, and an inductive coupling established by at least one inductance pathway between the first and second layer.

20. The computer system of claim 16, wherein modifying the S-parameter circuit includes modifying one or both of the at least one capacitance pathway and the at least one inductance pathway.
